(19) United States
(12) Patent Application Publication
(10) Pub. No.: US 2019/0345175 A1
(43) Pub. Date: Nov. 14, 2019

(54) METHOF FOR PRODUCING HYDRIDOSILANES

(71) Applicant: WACKER CHEMIE AG, Munich (DE)

(72) Inventor: Elke Fritz-Langhals, Ottobrunn (DE)

(21) Appl. No.: 16/467,645

(22) PCT Filed: Dec. 9, 2016
(86) PCT No.: PCT/EP2016/080479

§ 371 Date: Jun. 7, 2019

(51) Int. Cl. C07F 7/08

(52) U.S. Cl. CPC C07F 7/0896; C07F 7/0827

(57) ABSTRACT

The invention relates to a method for producing hydridosilanes, in which siloxanes containing Si—H groups are reacted in the presence of a cationic Si(II) compound as a catalyst.

The invention relates to a method for preparing hydridosilanes by reacting hydridosiloxanes in the presence of a cationic Si(II) compound as catalyst.

Hydridosilanes and hydridosiloxanes play an important role in technology. This addition of vinyl compounds generally referred to as hydrosilylation is used, for example, for crosslinking silicone polymers and is widely used for linking functional groups to a silicon center via a carbon spacer.

Hydridosilanes have industrial significance, particularly acquired in the electronics industry. For example, dimethylsilane is used in the CVD process for producing dielectric coatings.

An uncomplicated, reliable and cost-effective method for preparing the highly flammable and highly reactive hydridosilanes is therefore of major industrial importance. In particular, there are high purity requirements for applications of hydridosilanes in the electronics industry. Subsequent purification of the hydridosilanes, by distillation for example, considerably increases the cost of the production process due to the necessary safety-related burden.

WO 2007/005037 describes a process in which hydridosilanes can be produced in the presence of Lewis-acidic boron compounds of the general formula BR₃ as catalyst, especially the boron compound B(C₆F₅)₃. In this reaction also referred to as disproportionation, hydridosilanes are formed from siloxanxes comprising Si—H groups, wherein higher molecular weight siloxanes comprising Si—H groups are also formed. A disadvantage of this process—as described in the working examples and also in Macromolecules 2006, 39, 3802—is that siloxane cycles are formed as undesired by-products to a considerable extent. A further disadvantage is that the catalyst B(C₆F₅)₃ is consumed in the course of the reaction forming catalytically inactive compounds, particularly dimethyl(pentafluorophenyl)silane. Thus, the risk exists that the reaction comes to a standstill prematurely. For high conversion, therefore, proportionately high amounts of catalyst have to be used, which renders the process considerably more costly. There is also the risk that the decomposition products formed, especially dimethyl(pentafluorophenyl)silane, owing to its high volatility, cannot be completely separated from the H-silanes formed, whereby losses in the quality of the silanes produced have to be accepted.

The object of the present invention therefore consists of providing a method for preparing hydridosilanes which does not have the disadvantages specified.

The present invention relates to a method for preparing hydridosilanes, in which siloxanes comprising Si—H groups are reacted in the presence of a cationic Si(II) compound as catalyst.

Surprisingly, it has been found that cationic Si(II) compounds catalyze the reaction specified and, despite their generally known high chemical reactivity, are stable under the reaction conditions in contrast to the Lewis-acidic boron compounds, whereby the production process is significantly simplified. When using the Lewis-acidic boron compound B(C₆F₅)₃, several fluorine-containing by-products are found after the reaction, which are no longer catalytically active. Fluorine-containing organic compounds are of toxicological concern however, and are therefore industrially undesirable.

Although the counterions of the cationic Si(II) compounds used are often fluorine-containing boranates, such as B(C₆F₅)₄⁻, these are stable under the reaction conditions and do not decompose to form volatile fluorine compounds.

A further advantage is that substantially fewer siloxane cycles are formed when using cationic Si(II) compounds.

Finally, the reactivity of the cationic Si(II) compound can be controlled by the selection of the anion, which is of technical advantage.

In addition to the hydridosilanes, higher molecular weight siloxanes comprising Si—H groups are formed in the method.

The siloxane comprising Si—H groups used for the method preferably has the general formula I

R¹R²RSiO_{(1/2)}Z (I),

wherein
Z signifies the general formula Ia

(SiO_{4/2})ₐ(R^{x}SiO₃₂)_{b}(R^{X}₂SiO_{2/2})_{c}(R^{x}₃SiO_{1/2})_{d} (Ia)
R¹ and R² are each independently hydrocarbon radicals, halogen atoms or hydrogen atoms,
R^{x} are each independently hydrogen, halogen, an unbranched, branched, linear, acyclic or cyclic, saturated or mono- or polyunsaturated C1-C20 hydrocarbon radical or an unbranched, branched, linear or cyclic, saturated or mono- or polyunsaturated C1-C20 hydrocarbonoxy radical, wherein in each case individual non-adjacent CH₂ groups can be replaced by oxygen or sulfur atoms and individual CH groups can be replaced by nitrogen atoms and in each case the carbon atoms may bear halogen substituents, and
   a, b, a and d are each independently in each case integer values from 1 to 10 000,
   wherein the sum total of a, b, c and d together has at least the value I.

The radicals R¹ and R² are particularly preferably each independently hydrogen, halogen, unbranched, branched, acyclic or cyclic, saturated or mono- or polyunsaturated C1-C20 hydrocarbon radicals.

The radicals R¹ and R² are especially preferably each independently hydrogen, chlorine, linear saturated C1-C10 radicals, cyclic saturated or mono- or polyunsaturated C1-C10 hydrocarbon radicals.

The radicals R¹ and R² are most especially preferably each independently hydrogen, chlorine, linear or branched saturated C1-C3 radicals, cyclic saturated or mono- or polyunsaturated C1-C6 hydrocarbon radicals.

Preferred examples of the radicals R¹ and R² are hydrogen, chlorine, methyl, ethyl, n-propyl, isopropyl, butyl, phenyl and benzyl.

The hydrocarbon radicals R^{x} are preferably methyl, ethyl, n-propyl, isopropyl, butyl, phenyl or benzyl radicals.

The hydrocarbon radicals R^{x} are preferably methoxy, ethoxy, n-propoxy or isopropoxy radicals.

Preferably, a, b, c and d are each independently integer values from 0 to 1000, particularly preferably from 0 to 500 and especially preferably from 0 to 100.

The sum total of a, b, c and d is preferably at least 1 to 10, especially 1 to 5.

It is also possible to use mixtures of different siloxanes of the general formula I.

The hydridosilane formed in the method according to the invention preferably has the general formula II

R¹R²H₂Si (II)

wherein the radicals R¹ and R² have the definitions and preferred definitions specified above.

Examples of the siloxanes of the general formula I used are 1,1,2,2-tetramethyldisiloxane, 1,1,1,2,2-pentamethyldisiloxane, 1,1,2,2,3,3-hexamethyltrisiloxane, 1,1,1,2,2,3,3-heptamethyltrisiloxane, 1,1,2,2,3,3,4,4-octamethyltetrasiloxane and higher homologs of the general formula II:

H—SiMe₂-O—(SiMe₂-O)ₙ—SiMe₂-O—SiMe₂-H or

H—SiMe₂-O—(SiMe₂-O)ₙ—SiMe₂-O—SiMe₃

where n can have values from 0 to 10 000.

The reaction takes place in the presence of one or more cationic Si(II) compounds.

Preferably, a cationic Si(II) compound of the general formula III

([si(II)Cp]⁺)ₐX^{a-} (III)

is used, wherein
Cp is a π-bonded cyclopentadienyl radical of the general formula IV, which is substituted by the radicals R^{y},

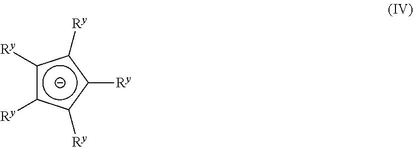

R^{y} are any monovalent radicals or polyvalent radicals, which can also be bonded to one another to form fused rings,
X^{a-} is any a valent anion, which does not react with the cationic silicon (II) center under the reaction conditions and
a has integer values from 1 to 6.

Cyclopentadienyl radical Cp is understood to mean the cyclopentadienyl anion, which consists of a singly negatively charged aromatic five-membered ring system C₅R^{y}₅⁻.

The radicals R^{y} are each independently preferably hydrogen, linear or branched, acyclic or cyclic, saturated or mono- or polyunsaturated C1-C20 alkyl or aryl, particularly preferably C1-C3 alkyl, especially preferably methyl radicals.

Examples of radicals R^{y} are alkyl radicals such as the methyl, ethyl, n-propyl, isopropyl, n-butyl, sec-butyl, isobutyl, tert-butyl, n-pentyl, sec-pentyl, isopentyl, neopentyl, tert-pentyl radical; hexyl radicals such as the n-hexyl radical; heptyl radicals such as the n-heptyl radical; octyl radicals such as the n-octyl radical and isooctyl radicals such as the 2,4,4-trimethylpentyl radical; nonyl radicals such as the n-nonyl radical; decyl radicals such as the n-decyl radical; dodecyl radicals such as the n-dodecyl radical; hexadecyl radicals such as the n-hexadecyl radical; octadecyl radicals such as the n-octadecyl radical; cycloalkyl radicals such as the cyclopentyl, cyclohexyl, cycloheptyl radical and methylcyclohexyl radical; aryl radicals such as the phenyl, naphthyl, anthryl and phenanthryl radical; alkaryl radicals such as the o-, m- and p-tolyl, xylyl, mesitylenyl and o-, m- and p-ethylphenyl radical; and aralkyl radicals such as the benzyl radical, the α- and β-phenylethyl radical.

X^{a-} can be either inorganic or organic. Preferably, a has the values 1, 2, or 3, especially 1.

X⁻ is preferably halogen or a complex anion such as BF₄⁻, ClO₄⁻, AlZ₄⁻, MF₆⁻ where Z=halogen and M=P, As or Sb, or tetraaryl borate anion, wherein the aryl radical is preferably phenyl or fluorinated phenyl or phenyl substituted by perfluoroalkyl radicals, monovalent polyhedral anion such as carborate anion for example, or alkoxymetallate ion and aryloxymetallate ion.

Examples of anions X⁻ are tetrachlorometallates [MCl₄]⁻ where M=Al, Ga, tetrafluoroborates [BF₄]⁻, hexafluorometallates [MF₆]⁻ where M=As, Sb, Ir, Pt, perfluoroantimonates [Sb₂F₁₁]⁻, [Sb₃F₁₆]⁻ and [Sb₄F₂₁]⁻, triflate (=trifluoromethanesulfonate) [OSO₂CF₃]⁻, tetrakis(trifluoromethyl)borate [B(CF₃)₄]⁻, tetrakis(pentafluorophenyl)metallates [M(C₆F₅)₄]⁻ where M=B, Al, Ga, tetrakis(pentachlorophenyl)borate [B(C₆Cl₅)₄]⁻, tetrakis[(2,4,6-trifluoromethyl(phenyl)]borate {B[C₆H₂(CF₃)₃]}⁻, [bis[tris(pentafluorophenyl)] hydroxide {HO[B(C₆F₅)₃]₂}⁻, closo-carborates [CHB₁₁H₅Cl₆]⁻, [CHB₁₁H₅Br₆]⁻, [CHB₁₁(CH₃)₅Br₆]⁻, [CHB₁₁F₁₁]⁻, [C(Et)B₁₁F₁₁]⁻, [CB₁₁(CF₃)₁₂]⁻ and B₁₂Cl₁₁N(CH₃)₃]⁻, tetra(perfluoroalkoxy)aluminates [Al(OR^{PF})₄]⁻, tris(perfluoroalkoxy)fluoroaluminates [FAl(OR^{PF})₃]⁻, hexakis(oxypentafluorotellurium)antimonate [Sb(OTeF₅)₆]⁻.

An overview of particularly preferred complex anions X⁻ can be found, for example, in Krossing et. al., Angew. Chem. 2004, 116, 2116.

The cationic Si(II) compound of the general formula III can be prepared by adding an acid H⁺X⁻ to the compound Si(II)Cp₂, whereupon one of the anionic Cp radicals is eliminated in protonated form:

Si(II)Cp₂+H⁺X⁻→Si(II)⁺CpX⁻+CpH

The anion X⁻ of the acid HX then forms the counterion of the cationic silicon(II) compound.

A preparation method for the cationic Si(II) compound of the general formula III is described in Science 2004, 305, pp. 849-851:

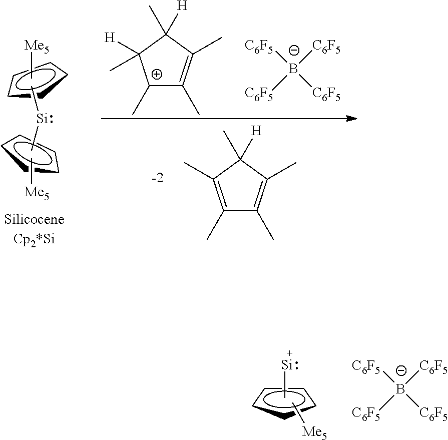

The cationic Si(II) compound of the general formula III is formed therein with the aid of the acid (Cp*H₂)⁺B(C₆F₅)₄⁻ (Cp*=pentamethylcyclopentadienyl). In this case, the compound of the formula III is obtained where the counterion X⁻═B(C₆F₅)₄⁻, which can be very readily crystallized and can therefore be particularly readily isolated. However, the compound of the general formula III can also be produced by adding other Bronstedt acids, wherein acids are preferred of which the anions correspond to the requirements of weak coordination specified above.

Further examples of cationic silicon(II) compounds are the structures below:

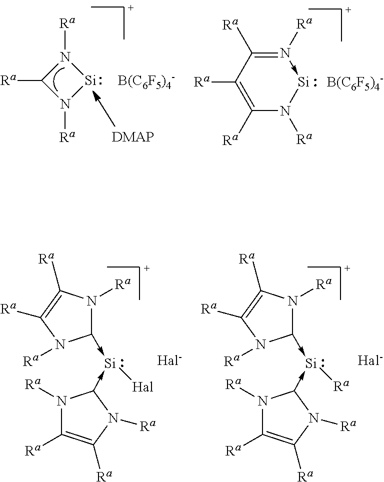

the preparation of which is described in So et al, Chem. Eur. J. 2013, 19, 11786, Driess et al., Angew. Chem. Int. Ed. 2006, 45, 6730, Filippou, Angew. Chem. Int. Ed. 2013, 52, 6974, Sasamori et al, Chem. Eur. J. 2014, 20, 9246 and in Inoue et al., Chem. Commun. 2014, 50, 12619 (DMAP=dimethylaminopyridine).

In the formulae above, R^{a} are hydrocarbon radicals. Preferably, the radicals R^{a} are each independently alkyl radicals, especially C1-C20-alkyl radicals or substituted or unsubstituted phenyl radicals, particularly preferably branched alkyl radicals or 2,6-dialkylated phenyl radicals. Hal is halogen, preferably chlorine, bromine or iodine. Examples of radicals R^{a} are methyl, isopropyl, tert-butyl, 2,6-diisopropylphenyl or 2,4,6-triisopropylphenyl.

The proportion by weight of the cationic Si(II) compound, based on the total mass of siloxanes comprising Si—H groups, is preferably at least 10⁻⁵¹% by weight (0.1 ppm) and at most 20% by weight, particularly preferably at least 10⁻⁵% by weight (1 ppm) and at most 5% by weight and especially preferably at least 10⁻³% by weight (10 ppm) and at most 1% by weight.

The reaction according to the invention can be carried out with or without addition of one or more solvents. The proportion of solvent or solvent mixture, based on the siloxanes comprising Si—H groups, is preferably at least 0.1% by weight and at most 1000-fold the amount by weight, particularly preferably at least 10% by weight and at most 100-fold the amount by weight, especially preferably at least 30% by weight and at most 10-fold the amount by weight.

The solvents used can be preferably aprotic solvents, for example hydrocarbons such as pentane, hexane, heptane, cyclohexane or toluene, chlorohydrocarbons such as dichloromethane, chloroform, chlorobenzene or 1,2-dichloroethane, ethers such as diethyl ether, methyl tert-butyl ether, anisole, tetrahydrofuran or dioxane, or nitriles such as e.g. acetonitrile or propionitrile.

The reaction can be carried out at ambient pressure or under reduced pressure or elevated pressure.

The pressure is preferably at least 0.01 bar and at most 100 bar, particularly preferably at least 0.1 bar and at most 10 bar, especially preferably the reaction is carried out at ambient pressure.

The reaction according to the invention is preferably conducted at temperatures between at least −100° C. and at most +250° C., particularly preferably between at least −20° C. and at most 150° C., especially preferably between at least 0° C. and at most 100° C.

The considerably more volatile silanes of the general formula II, compared to the higher siloxanes also formed in the reaction, can be removed from the siloxanes in a particularly simple manner by distillation. In this way, the separation can already be effected during the reaction.

All aforementioned symbols relating to the formulae above have definitions in each case that are each independent of one another. In all formulae, the silicon atom is tetravalent.

### EXAMPLES

Unless stated otherwise in each case, all amounts and percentages are based on weight and all temperatures are 20° C.

Gas chromatograms were recorded using a Model A6890 plus gas chromatograph from Agilent. Column used: HP-5, No. U.S. Pat. No. 2,441,516H, 30 m, 0.32 mm, 0.25 μm, temperature: 40° C.-120° C. at 5° C./min.; from 120° C. to 300° C. at 10° C./min.; injector: 290° C., split 1:250, 1.0 μl, carrier gas He 1.5 ml/min.; detector: FID, 320° C. The products were identified by comparison with authentic material.

In the following examples, the conversion was determined in each case by ¹H-NMR spectroscopy. For this purpose, the integral of the hydrogens of the silanes formed (dimethylsilane at δ=3.8 and trimethylsilane at δ=4.0) and the total integral of all hydrogens on siloxane moieties at δ=4.7-4.8 were determined and the conversion was calculated according to the following equation.

Conversion (%)=100×I(silanes)/[I(siloxanes)÷I(silanes)]

### Example 1: Disproportionation of 1,1,1,2,2-pentamethyldisiloxane in the Presence of (π-Me₅C₅)Si⁺B(C₆F₅)₄⁻

All working steps were conducted under Ar.

296 mg (2.00 mmol) of pentamethyldisiloxane were dissolved in 1.0 ml of d₂-dichloromethane and a solution of 1.8 mg (0.0021 mmol, 0.11 mol %) of (π-Me₅C₅)Si⁺B(C₆F₅)₄⁻ was added at 20° C. The reaction was monitored by NMR spectroscopy. After 45 minutes, the reactant pentamethyldisiloxane was no longer detectable by NMR spectroscopy and the NMR shows the formation of higher molecular weight siloxanes comprising H groups. The silanes dimethylsilane and trimethylsilane were formed in the molar ratio of 70:30

### Conversion=95%.

### Example 2: Disproportionation of 1,1,2,2-tetramethyldisiloxane in the Presence of (π-Me₅C₅)Si⁺B(C₆F₅)₄⁻

All working steps were conducted under Ar.

269 mg (2.00 mmol) of tetramethyldisiloxane were dissolved in 1.5 ml of d₂-dichloromethane and 1.9 mg (0.00226 mmol, 0.11 mol %) of (π-Me₅C₅)Si⁺B(C₆F₅)₄⁻ were added at room temperature (ca. 23° C.) with shaking. The reaction was stopped with pyridine after 30 minutes and the reaction mixture was investigated by NMR spectroscopy. The silane formed was exclusively dimethylsilane.

### Conversion=70%

The other products were determined by gas chromatography.

The following products were detected by comparison with authentic material (retention times and area % in parentheses)—dimethylsilane was not detected in this case: 1,1,2,2-tetramethyldisiloxane (2.14 min., 15%), pyridine (3.24 min., 41%), 1,1,2,2,3,3-hexamethyltrisiloxane (3.95 min., 8.6%), 1,1,2,2,3,3,4,4-octamethyltetrasiloxane (7.99 min., 1.5%), 1,1,2,2,3,3,4,4,5,5-decamethylpentasiloxane (12.85 min., 8.6%), 1,1,2,2,3,3,4,4,5,5,6,6-dodecamethylhexasiloxane (17.23 min., 7.0%), 1,1,2,2,3,3,4,4,5,5,6,6,7,7-tetradecamethylheptasiloxane (20.08 min., 5.1%), 1,1,2,2,3,3,4,4,5,5,6,6,7,7,8,8-hexadecamethyloctasiloxane (22.16 min., 3.3%).

Siloxane cycles were not detected by gas chromatography.

### Example 3: Disproportionation of 1,1,2,2-tetramethyldisiloxane in the Presence of (π-Me₅C₅)Si⁺HB(C₆F₅)₃⁻

All working steps were conducted under Ar.

269 mg (2.00 mmol) of tetramethyldisiloxane were dissolved in 1.5 ml of d₂-dichloromethane and 1.4 mg (0.00207 mmol, 0.10 mol %) of (π-Me₅C₅)Si⁺HB(C₆F₅)₃⁻ were added at room temperature (ca. 23° C.) with shaking. The reaction was stopped with pyridine after 30 minutes and the reaction mixture was investigated by NMR spectroscopy. The silane formed was exclusively dimethylsilane.

### Conversion=45%

Siloxane cycles were not detected by gas chromatography.

### Example 4 (Non-Inventive, Formation of Siloxane Cycles): Disproportionation of 1,1,2,2-tetramethyldisiloxane in the Presence of B(C₆F₅)₃

268 mg (2.00 mmol) of tetramethyldisiloxane were dissolved in 1.5 ml of d₂-dichloromethane and 1.1 mg (0.00215 mmol, 0.11 mol %) of B(C₆F₅)₃ were added at room temperature (ca. 23° C.) with shaking. The reaction was stopped with pyridine after 30 minutes and the reaction mixture was investigated by NMR spectroscopy. The silane formed was exclusively dimethylsilane.

### Conversion=65%

The other products were determined by gas chromatography-dimethylsilane was not detected in this case. The following products were detected by comparison with authentic material (retention times and area % in parentheses): pyridine (3.20 min., 22%), 1,1,2,2,3,3-hexamethyltrisiloxane (3.92 min., 11.8%), hexamethylcyclotrisiloxane (4.27 min., 0.8%), 1,1,2,2,3,3,4,4-octamethyltetrasiloxane (7.97 min., 0.6%), octamethylcyclopentasiloxane (8.26 min., 10.0%), decamethylcyclopentasiloxane (12.49 min., 0.9%), 1,1,2,2,3,3,4,4,5,5-decamethylpentasiloxane (12.80 min., 1.0%), 1,1,2,2,3,3,4,4,5,5,6,6-dodecamethylhexasiloxane (17.21 min., 7.0%), tetradecamethylcycloheptasiloxane (20.03 min., 7.3%).

### Example 5 (Non-Inventive, Detection of Decomposition Product of the Lewis-Acidic Boron Catalyst)

All working steps were conducted under Ar. 268 mg (2.00 mmol) of tetramethyldisiloxane are dissolved in 1.5 ml of d₂-dichloromethane and 1.1 mg (0.00215 mmol, 0.1 mol %) of tris(pentafluorophenyl)boron were added. Dimethylsilane was formed. In the ¹⁹F-NMR spectrum, the formation of several fluorine-containing by-products was identified. After a reaction time of one hour, the formation of dimethyl(pentafluorophenyl)silane (M⁺=225) was detected by GC/MS analysis. The relative area percent in the GC was 0.2%.

1. A method for preparing hydridosilanes, comprising:
reacting siloxanes comprising Si—H groups in the presence of a cationic Si(II) compound as a catalyst.

2. The method of claim 1, wherein the siloxanes comprising Si—H groups have the general formula I
R¹R²HSiO_{(1/2)Z} (I),
wherein
Z signifies the general formula Ia
(SiO_{4/2})ₐ(R^{x}SiO_{3/2})_{b}(R^{x}₂SiO_{2/2})ₑ(R^{x}₃SiO_{1/2})_{d} (Ia)
R¹ and R² are each independently hydrocarbon radicals, halogen atoms or hydrogen atoms,
R^{x} are each independently hydrogen, halogen, an unbranched, branched, linear, acyclic or cyclic, saturated or mono- or polyunsaturated C1-C20 hydrocarbon radical or an unbranched, branched, linear or cyclic, saturated or mono- or polyunsaturated C1-C20 hydrocarbonoxy radical, wherein in each case individual non-adjacent CH₂ groups can be replaced by oxygen or sulfur atoms and individual CH groups can be replaced by nitrogen atoms and in each case the carbon atoms may bear halogen substituents, and a, b, c and d are each independently in each case integer values from 1 to 10,000, wherein the sum total of a, b, c and d together has at least the value 1.

3. The method of claim 2, wherein R¹ and R² are radicals and are each independently hydrogen, chlorine, linear saturated C1-C10 radicals, cyclic saturated or mono- or polyunsaturated C1-C10 hydrocarbon radicals.

4. The method of claim 2, wherein the radicals R^{x} are selected from the group consisting of methyl, ethyl, n-propyl, isopropyl, butyl, phenyl, benzyl, methoxy, ethoxy, n-propoxy and isopropoxy.

5. The method of claim 2, wherein the sum total of a, b, c and d is 1 to 10.

6. The method of claim 2, wherein the cationic Si(II) compound of the general formula III
([Si(II)Cp]⁺)ₐX^{a-} (III)
is used, wherein
Cp is a π-bonded cyclopentadienyl radical of the general formula IV, which is substituted by the radicals R^{y}, 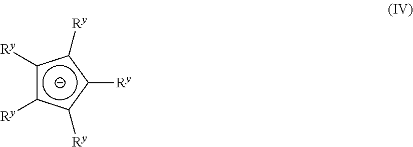
R^{y} are monovalent radicals or polyvalent radicals, which can also be bonded to one another to form fused rings,
X^{a-} is an a valent anion, which does not react with the cationic silicon (II) compound center under the reaction conditions and
a has integer values from 1 to 6.

7. The method of claim 6, wherein R^{y} is each independently hydrogen, linear or branched, acyclic or cyclic, saturated or mono- or polyunsaturated C1-C20 alkyl or aryl.

8. The method of claim 6, wherein a has the value 1.

9. The method of claim 8, in which X⁻ is selected from halogen, BF₄⁻, ClO₄⁻, AlZ₄⁻, MF₆⁻ where Z=halogen and M=P, As or Sb, tetraaryl borate anion, wherein the aryl radical is phenyl or fluorinated phenyl or phenyl substituted by perfluoroalkyl radicals, carborate anion, alkoxymetallate ion and aryloxymetallate ion.

10. The method of claim 8, wherein the proportion by weight of the cationic Si(II) compound, based on the total mass of siloxanes comprising Si—H groups, is 10⁻⁵% by weight (0.1 ppm) to 5% by weight.
